(19) United States
(12) Patent Application Publication
(10) Pub. No.: US 2026/0113467 A1
(43) Pub. Date: Apr. 23, 2026

(54) ENCODING DEVICE, DECODING DEVICE, AND NON-TRANSITORY MACHINE-READABLE MEDIUM FOR ENCODING/DECODING VIDEO DATA

(71) Applicant: SHARP KABUSHIKI KAISHA, Sakai City (JP)

(72) Inventors: KAI-WEN LIANG, New Taipei City (TW); CHIH-YU TENG, New Taipei City (TW); YI-HAO LIN, New Taipei City (TW); YU-CHIAO YANG, New Taipei City (TW)

(21) Appl. No.: 19/365,852

(22) Filed: Oct. 22, 2025

Related U.S. Application Data
(60) Provisional application No. 63/710,177, filed on Oct. 22, 2024.

(51) Int. Cl. H04N 19/196; H04N 19/105; H04N 19/159; H04N 19/176; H04N 19/513

(52) U.S. Cl. CPC H04N 19/196; H04N 19/105; H04N 19/159; H04N 19/176; H04N 19/521

(57) ABSTRACT

An electronic device for decoding/encoding video data is provided. The electronic device receives the video data and determines a block unit from an image frame retrieved from the video data. The electronic device determines a first block vector from a neighboring block of the block unit, where the first block vector indicates a first reference block. The electronic device further determines, based on the first reference block, and using a matrix-based intra prediction mode, a first block prediction for the block unit when the first reference block satisfies a condition associated with a block size and a mode type of the first reference block. The electronic device then reconstructs the block unit based on the first block prediction. In addition, a non-transitory machine-readable medium for decoding/encoding video data is also provided.

### CROSS-REFERENCE TO RELATED APPLICATION(S)

The present disclosure claims the benefit of and priority to U.S. Provisional Patent Application Ser. No. 63/710,177, filed on Oct. 22, 2024, entitled “BLOCK VECTOR GUIDED PDP MODE FOR INTRA PREDICTION,” the content of which is hereby incorporated herein fully by reference in its entirety into the present disclosure for all purposes.

### FIELD

The present disclosure is generally related to video coding and, more specifically, to techniques for integrating block vectors with matrix-based intra prediction modes to enhance block unit reconstruction in video decoding.

### BACKGROUND

Video coding has become essential for efficient storage and transmission of digital media, enabling applications from streaming services to high-definition broadcasting. Standards like H.264/AVC, HEVC, and VVC have evolved to compress video data by exploiting spatial and temporal redundancies, dividing frames into blocks for prediction, transformation, quantization, and entropy coding. Intra prediction, a key component, generates predictions within the same frame using neighboring reconstructed samples, reducing data sent to the decoder. Common intra modes include directional modes (e.g., angular modes) simulating edges at various angles, non-directional modes (e.g., Planar and DC modes), and advanced tools such as most probable modes (MPMs) derived from adjacent blocks to minimize signaling overhead.

As video resolutions increase, intra prediction faces demands for higher accuracy with lower computational overhead. Template-based approaches have emerged, where modes are derived by evaluating costs on reconstructed template regions adjacent to the current block, allowing decoder-side mode selection without explicit signaling. Meanwhile, matrix-based modes apply weighted combinations of reference samples via predefined matrices, offering position-dependent predictions that can outperform traditional modes for certain block geometries.

However, limitations in balancing complexity and performance may be encountered. For instance, matrix-based modes are typically restricted to using immediately adjacent reference samples, which may not capture optimal correlations in cases of repetitive patterns or displaced content within the frame, leading to reduced prediction accuracy for certain block units. These challenges highlight the need for refined harmonization strategies to maintain coding gains without exacerbating resource demands in modern video ecosystems.

### SUMMARY

The present disclosure is directed to a device and method for integrating block vectors with matrix-based intra prediction modes to enhance block unit reconstruction in video decoding, aimed at enhancing the accuracy and efficiency of block unit reconstruction in video decoding by leveraging displaced reference blocks and matrix-based predictions.

According to a first aspect of the present disclosure, an electronic device for decoding video data is provided. The electronic device includes at least one processor and at least one non-transitory computer-readable medium coupled to the at least one processor and storing one or more computer-executable instructions. When executed by the at least one processor, the instructions cause the electronic device to: receive the video data; determine a block unit from an image frame retrieved from the video data; determine a first block vector from a neighboring block of the block unit, the first block vector indicating a first reference block; determine, based on the first reference block and using a matrix-based intra prediction mode, a first block prediction for the block unit when the first reference block satisfies a condition associated with a block size and a mode type of the first reference block; and reconstruct the block unit based on the first block prediction.

In an implementation of the first aspect, determining the first block prediction for the block unit includes: determining, based on a reference region of the first reference block and using the matrix-based intra prediction mode, a reference prediction for the first reference block.

In another implementation of the first aspect, the reference region includes a reference line adjacent to the first reference block.

In another implementation of the first aspect, the reference region includes a reference line separated from a boundary of the first reference block.

In another implementation of the first aspect, the reference line is separated from the boundary of the first reference block by one or more pixels in width, and the reference line is located within a reconstructed region.

In another implementation of the first aspect, the one or more computer-executable instructions, when executed by the at least one processor, further cause the electronic device to: add the first block prediction as a prediction candidate to multiple prediction candidates for the block unit. Reconstructing the block unit based on the first block prediction includes reconstructing the block unit based on the multiple prediction candidates.

In another implementation of the first aspect, the one or more computer-executable instructions, when executed by the at least one processor, further cause the electronic device to: determine a second block vector from another neighboring block of the block unit, the second block vector indicating a second reference block; determine, based on the second reference block and using the matrix-based intra prediction mode, a second block prediction for the block unit when the second reference block satisfies the condition; and add the second block prediction as another prediction candidate to the multiple prediction candidates for the block unit.

In another implementation of the first aspect, the first reference block satisfies the condition when: each of a block width of the first reference block and a block height of the first reference block is smaller than or equal to 16 pixels, and the mode type of the first reference block is one of a planar mode, a direct current (DC) mode, and an angular mode having a mode index defined by a function of k, where k is a positive constant.

In another implementation of the first aspect, the first reference block satisfies the condition when: at least one of a block width of the first reference block and a block height of the first reference block is greater than or equal to 32 pixels, and the mode type of the first reference block is one of a planar mode, a direct current (DC) mode, and an angular mode having a mode index defined by a function of k, where k is a positive constant.

According to a second aspect of the present disclosure, an electronic device for encoding video data is provided. The electronic device includes: at least one processor; and at least one non-transitory computer-readable medium coupled to the at least one processor and storing one or more computer-executable instructions. When executed by the at least one processor, the instructions cause the electronic device to: receive the video data; determine a block unit from an image frame retrieved from the video data; determine a first block vector from a neighboring block of the block unit, the first block vector indicating a first reference block; determine, based on the first reference block and using a matrix-based intra prediction mode, a first block prediction for the block unit when the first reference block satisfies a condition associated with a block size and a mode type of the first reference block; and reconstruct the block unit based on the first block prediction.

In an implementation of the second aspect, determining the first block prediction for the block unit includes: determining, based on a reference region of the first reference block and using the matrix-based intra prediction mode, a reference prediction for the first reference block.

In another implementation of the second aspect, the reference region includes a reference line adjacent to the first reference block.

In another implementation of the second aspect, the reference region includes a reference line separated from a boundary of the first reference block.

In another implementation of the second aspect, the reference line is separated from the boundary of the first reference block by one or more pixels in width, and the reference line is located within a reconstructed region.

In another implementation of the second aspect, the one or more computer-executable instructions, when executed by the at least one processor, further cause the electronic device to: add the first block prediction as a prediction candidate to multiple prediction candidates for the block unit. Reconstructing the block unit based on the first block prediction includes reconstructing the block unit based on the multiple prediction candidates.

In another implementation of the second aspect, the one or more computer-executable instructions, when executed by the at least one processor, further cause the electronic device to: determine a second block vector from another neighboring block of the block unit, the second block vector indicating a second reference block; determine, based on the second reference block and using the matrix-based intra prediction mode, a second block prediction for the block unit when the second reference block satisfies the condition; and add the second block prediction as another prediction candidate to the multiple prediction candidates for the block unit.

In another implementation of the second aspect, the first reference block satisfies the condition when: each of a block width of the first reference block and a block height of the first reference block is smaller than or equal to 16 pixels, and the mode type of the first reference block is one of a planar mode, a direct current (DC) mode, and an angular mode having a mode index defined by a function of k, where k is a positive constant.

In another implementation of the second aspect, the first reference block satisfies the condition when: at least one of a block width of the first reference block and a block height of the first reference block is greater than or equal to 32 pixels, and the mode type of the first reference block is one of a planar mode, a direct current (DC) mode, and an angular mode having a mode index defined by a function of k, where k is a positive constant.

According to a third aspect of the present disclosure, a non-transitory machine-readable medium of an electronic device is provided. The non-transitory machine-readable medium stores one or more computer-executable instructions for decoding video data. The one or more computer-executable instructions, when executed by at least one processor of the electronic device, cause the electronic device to: receive the video data; determine a block unit from an image frame retrieved from the video data; determine a first block vector from a neighboring block of the block unit, the first block vector indicating a first reference block; determine, based on the first reference block and using a matrix-based intra prediction mode, a first block prediction for the block unit when the first reference block satisfies a condition associated with a block size and a mode type of the first reference block; and reconstruct the block unit based on the first block prediction.

### BRIEF DESCRIPTION OF THE DRAWINGS

Aspects of the present disclosure are best understood from the following detailed disclosure and the corresponding figures. Various features are not drawn to scale and dimensions of various features may be arbitrarily increased or reduced for clarity of discussion.

FIG. 1 is a block diagram illustrating a system having a first electronic device and a second electronic device for encoding and decoding video data, in accordance with one or more example implementations of the present disclosure.

FIG. 2 is a block diagram illustrating a decoder module of the second electronic device illustrated in FIG. 1, in accordance with one or more example implementations of the present disclosure.

FIG. 3 is a flowchart illustrating a method/process for decoding and/or encoding video data by an electronic device, in accordance with one or more example implementations of the present disclosure.

FIG. 4 is a diagram illustrating adjacent blocks of a block unit, in accordance with one or more example implementations of the present disclosure.

FIG. 5 is a diagram illustrating adjacent and non-adjacent blocks of a block unit, in accordance with one or more example implementations of the present disclosure.

FIG. 6 is a diagram illustrating a block vector indicating a reference block, in accordance with one or more example implementations of the present disclosure.

FIG. 7 is a diagram illustrating a reference region of a target block unit, in accordance with one or more example implementations of the present disclosure.

FIG. 8 is a block diagram illustrating an encoder module of the first electronic device illustrated in FIG. 1, in accordance with one or more example implementations of the present disclosure.

### DETAILED DESCRIPTION

The following disclosure contains specific information pertaining to implementations in the present disclosure. The figures and the corresponding detailed disclosure are directed to example implementations. However, the present disclosure is not limited to these example implementations. Other variations and implementations of the present disclosure will occur to those skilled in the art.

Unless noted otherwise, like or corresponding elements among the figures may be indicated by like or corresponding reference designators. The figures and illustrations in the present disclosure are generally not to scale and are not intended to correspond to actual relative dimensions.

For the purposes of consistency and ease of understanding, features are identified (although, in some examples, not illustrated) by reference designators in the exemplary figures. However, the features in different implementations may differ in other respects and shall not be narrowly confined to what is illustrated in the figures.

The present disclosure uses the phrases “in one implementation,” or “in some implementations,” which may refer to one or more of the same or different implementations. The term “coupled” is defined as connected, whether directly or indirectly through intervening components, and is not necessarily limited to physical connections. The term “comprising” means “including, but not necessarily limited to” and specifically indicates open-ended inclusion or membership in the so-described combination, group, series, and the equivalent.

For purposes of explanation and non-limitation, specific details, such as functional entities, techniques, protocols, and standards, are set forth for providing an understanding of the disclosed technology. Detailed disclosure of well-known methods, technologies, systems, and architectures are omitted so as not to obscure the present disclosure with unnecessary details.

Persons skilled in the art will recognize that any disclosed coding function(s) or algorithm(s) described in the present disclosure may be implemented by hardware, software, or a combination of software and hardware. Disclosed functions may correspond to modules that are software, hardware, firmware, or any combination thereof.

A software implementation may include a program having one or more computer-executable instructions stored on a computer-readable medium, such as memory or other types of storage devices. For example, one or more microprocessors or general-purpose computers with communication processing capability may be programmed with computer-executable instructions and perform the disclosed function(s) or algorithm(s).

The microprocessors or general-purpose computers may be formed of application-specific integrated circuits (ASICs), programmable logic arrays, and/or one or more digital signal processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes, but is not limited to, random-access memory (RAM), read-only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-executable instructions. The computer-readable medium may be a non-transitory computer-readable medium.

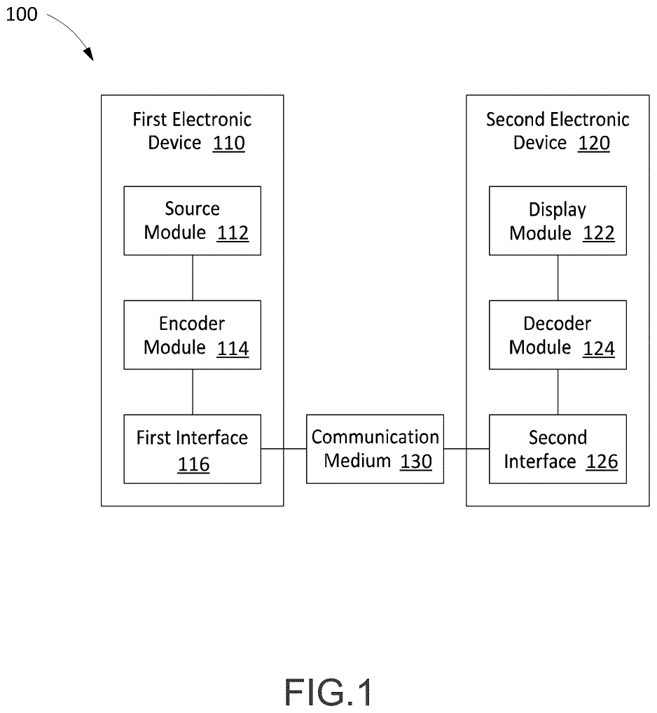

FIG. 1 is a block diagram illustrating a system 100 having a first electronic device and a second electronic device for encoding and decoding video data, in accordance with one or more example implementations of this disclosure.

The system 100 includes a first electronic device 110, a second electronic device 120, and a communication medium 130.

The first electronic device 110 may be a source device including any device configured to encode video data and transmit the encoded video data to the communication medium 130. The second electronic device 120 may be a destination device including any device configured to receive encoded video data via the communication medium 130 and decode the encoded video data.

The first electronic device 110 may communicate via wire, or wirelessly, with the second electronic device 120 via the communication medium 130. The first electronic device 110 may include a source module 112, an encoder module 114, and a first interface 116, among other components. The second electronic device 120 may include a display module 122, a decoder module 124, and a second interface 126, among other components. The first electronic device 110 may be a video encoder and the second electronic device 120 may be a video decoder.

The first electronic device 110 and/or the second electronic device 120 may be a mobile phone, a tablet, a desktop, a notebook, or other electronic devices. FIG. 1 illustrates one example of the first electronic device 110 and the second electronic device 120. The first electronic device 110 and second electronic device 120 may include greater or fewer components than illustrated or have a different configuration of the various illustrated components.

The source module 112 may include a video capture device to capture new video, a video archive to store previously captured video, and/or a video feed interface to receive the video from a video content provider. The source module 112 may generate computer graphics-based data, as the source video, or may generate a combination of live video, archived video, and computer-generated video, as the source video. The video capture device may include a charge-coupled device (CCD) image sensor, a complementary metal-oxide-semiconductor (CMOS) image sensor, or a camera.

The encoder module 114 and the decoder module 124 may each be implemented as any one of a variety of suitable encoder/decoder circuitry, such as one or more microprocessors, a central processing unit (CPU), a graphics processing unit (GPU), a system-on-a-chip (SoC), digital signal processors (DSPs), application-specific integrated circuits (ASICs), field-programmable gate arrays (FPGAs), discrete logic, software, hardware, firmware, or any combinations thereof. When implemented partially in software, a device may store the program having computer-executable instructions for the software in a suitable, non-transitory computer-readable medium and execute the stored computer-executable instructions using one or more processors to perform the disclosed methods. Each of the encoder module 114 and the decoder module 124 may be included in one or more encoders or decoders, any of which may be integrated as part of a combined encoder/decoder (CODEC) in a device.

The first interface 116 and the second interface 126 may utilize customized protocols or follow existing standards or de facto standards including, but not limited to, Ethernet, IEEE 802.11 or IEEE 802.15 series, wireless USB, or telecommunication standards including, but not limited to, Global System for Mobile Communications (GSM), Code-Division Multiple Access 2000 (CDMA2000), Time Division Synchronous Code Division Multiple Access (TD-SCDMA), Worldwide Interoperability for Microwave Access (WiMAX), Third Generation Partnership Project Long-Term Evolution (3GPP-LTE), or Time-Division LTE (TD-LTE). The first interface 116 and the second interface 126 may each include any device configured to transmit a compliant video bitstream via the communication medium 130 and to receive the compliant video bitstream via the communication medium 130.

The first interface 116 and the second interface 126 may include a computer system interface that enables a compliant video bitstream to be stored on a storage device or to be received from the storage device. For example, the first interface 116 and the second interface 126 may include a chipset supporting Peripheral Component Interconnect (PCI) and Peripheral Component Interconnect Express (PCIe) bus protocols, proprietary bus protocols, Universal Serial Bus (USB) protocols, Inter-Integrated Circuit (I2C) protocols, or any other logical and physical structure(s) that may be used to interconnect peer devices.

The display module 122 may include a display using liquid crystal display (LCD) technology, plasma display technology, organic light-emitting diode (OLED) display technology, or light-emitting polymer display (LPD) technology, with other display technologies used in some other implementations. The display module 122 may include a High-Definition display or an Ultra-High-Definition display.

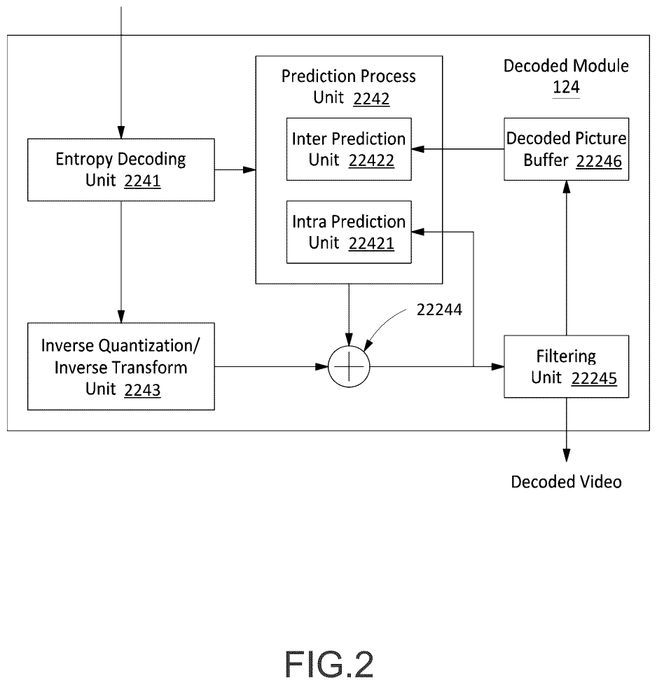

FIG. 2 is a block diagram illustrating a decoder module 124 of the second electronic device 120 illustrated in FIG. 1, in accordance with one or more example implementations of this disclosure. The decoder module 124 may include an entropy decoder (e.g., an entropy decoding unit 2241), a prediction processor (e.g., a prediction processing unit 2242), an inverse quantization/inverse transform processor (e.g., an inverse quantization/inverse transform unit 2243), a summer (e.g., a summer 2244), a filter (e.g., a filtering unit 2245), and a decoded picture buffer (e.g., a decoded picture buffer 2246). The prediction processing unit 2242 further may include an intra prediction processor (e.g., an intra prediction unit 22421) and an inter prediction processor (e.g., an inter prediction unit 22422). The decoder module 124 receives a bitstream, decodes the bitstream, and outputs a decoded video.

The entropy decoding unit 2241 may receive the bitstream including multiple syntax elements from the second interface 126, as shown in FIG. 1, and perform a parsing operation on the bitstream to extract syntax elements from the bitstream. As part of the parsing operation, the entropy decoding unit 2241 may entropy decode the bitstream to generate quantized transform coefficients, quantization parameters, transform data, motion vectors, intra modes, partition information, and/or other syntax information.

The entropy decoding unit 2241 may perform context-adaptive variable length coding (CAVLC), context-adaptive binary arithmetic coding (CABAC), syntax-based context-adaptive binary arithmetic coding (SBAC), probability interval partitioning entropy (PIPE) coding, or another entropy coding technique to generate the quantized transform coefficients. The entropy decoding unit 2241 may provide the quantized transform coefficients, the quantization parameters, and the transform data to the inverse quantization/inverse transform unit 2243 and provide the motion vectors, the intra modes, the partition information, and other syntax information to the prediction processing unit 2242.

The prediction processing unit 2242 may receive syntax elements, such as motion vectors, intra modes, partition information, and other syntax information, from the entropy decoding unit 2241. The prediction processing unit 2242 may receive the syntax elements including the partition information and divide image frames according to the partition information.

Each of the image frames may be divided into at least one image block according to the partition information. The at least one image block may include a luminance block for reconstructing multiple luminance samples and at least one chrominance block for reconstructing multiple chrominance samples. The luminance block and the at least one chrominance block may be further divided to generate macroblocks, coding tree units (CTUs), coding blocks (CBs), sub-divisions thereof, and/or other equivalent coding units.

During the decoding process, the prediction processing unit 2242 may receive predicted data including the intra mode or the motion vector for a current image block of a specific one of the image frames. The current image block may be the luminance block or one of the chrominance blocks in the specific image frame.

The intra prediction unit 22421 may perform intra-predictive coding of a current block unit relative to one or more neighboring blocks in the same frame as the current block unit based on syntax elements related to the intra mode in order to generate a predicted block. The intra mode may specify the location of reference samples selected from the neighboring blocks within the current frame. The intra prediction unit 22421 may reconstruct multiple chroma components of the current block unit based on multiple luma components of the current block unit when the multiple chroma components is reconstructed by the prediction processing unit 2242.

The intra prediction unit 22421 may reconstruct multiple chroma components of the current block unit based on the multiple luma components of the current block unit when the multiple luma components of the current block unit are reconstructed by the prediction processing unit 2242.

The inter prediction unit 22422 may perform inter-predictive coding of the current block unit relative to one or more blocks in one or more reference image blocks based on syntax elements related to the motion vector in order to generate the predicted block.

The motion vector may indicate a displacement of the current block unit within the current image block relative to a reference block unit within the reference image block. The reference block unit may be a block (e.g., in a reference frame) determined to closely match the current block unit.

The inter prediction unit 22422 may receive the reference image block stored in the decoded picture buffer 2246 and reconstruct the current block unit based on the received reference image blocks.

The inverse quantization/inverse transform unit 2243 may apply inverse quantization and inverse transformation to reconstruct the residual block in the pixel domain. The inverse quantization/inverse transform unit 2243 may apply inverse quantization to the residual quantized transform coefficient to generate a residual transform coefficient and then apply inverse transformation to the residual transform coefficient to generate the residual block in the pixel domain.

The inverse transformation may be inversely applied by the transformation process, such as a discrete cosine transform (DCT), a discrete sine transform (DST), an adaptive multiple transform (AMT), a mode-dependent non-separable secondary transform (MDNSST), a Hypercube-Givens transform (HyGT), a signal-dependent transform, a Karhunen-Loéve transform (KLT), a wavelet transform, an integer transform, a sub-band transform, or a conceptually similar transform. The inverse transformation may convert the residual information from a transform domain, such as a frequency domain, back to the pixel domain, etc. The degree of inverse quantization may be modified by adjusting a quantization parameter.

The summer 2244 may add the reconstructed residual block (e.g., residual samples of the block) to the predicted block (e.g., predicted samples of the block) provided by the prediction processing unit 2242 to produce a reconstructed block.

The filtering unit 2245 may include a deblocking filter, a sample adaptive offset (SAO) filter, a bilateral filter, and/or an adaptive loop filter (ALF) to remove the blocking artifacts from the reconstructed block. Additional filters (in loop or post loop) may also be used in addition to the deblocking filter, the SAO filter, the bilateral filter, and the ALF. Such filters (which are not explicitly illustrated for the brevity of description) may filter the output of the summer 2244. The filtering unit 2245 may output the decoded video to the display module 122 or other video receiving units after the filtering unit 2245 performs the filtering process for the reconstructed blocks of the specific image frame.

The decoded picture buffer 2246 may be a reference picture memory that stores the reference block to be used by the prediction processing unit 2242 in decoding the bitstream (e.g., in inter-coding modes). The decoded picture buffer 2246 may be formed by any one of a variety of memory devices, such as a dynamic random-access memory (DRAM), including synchronous DRAM (SDRAM), magneto-resistive RAM (MRAM), resistive RAM (RRAM), or other types of memory devices. The decoded picture buffer 2246 may be on-chip along with other components of the decoder module 124 or may be off-chip relative to those components.

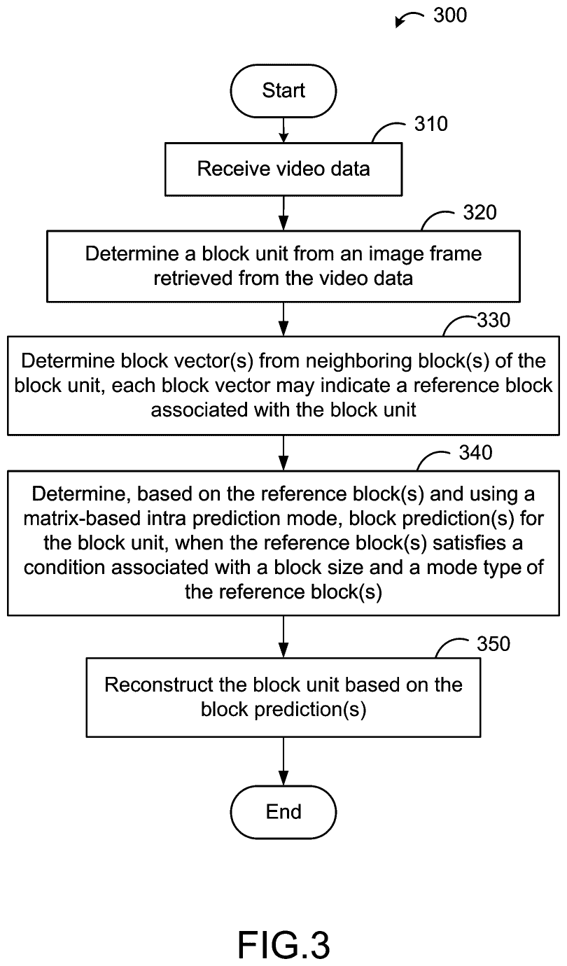

FIG. 3 is a flowchart illustrating a method/process 300 for decoding and/or encoding video data by an electronic device, in accordance with one or more example implementations of this disclosure. The method/process 300 is an example implementation, as there may be a variety of methods of decoding/encoding the video data.

The method/process 300 may be performed by an electronic device, such as the electronic device 110 or electronic device 120, using the configurations illustrated in FIGS. 1 and 2, where various elements of these figures may be referenced to describe the method/process 300. Each block illustrated in FIG. 3 may represent one or more processes, methods, or subroutines performed by an electronic device.

The order in which the blocks appear in FIG. 3 is for illustration only, and may not be construed to limit the scope of the present disclosure, thus may be different from what is illustrated. Additional blocks may be added or fewer blocks may be utilized without departing from the scope of the present disclosure.

At block 310, the method/process 300 may start by receiving (e.g., by the decoder module 124) the video data. The video data received by the decoder module 124 may include a bitstream provided by the encoder module 114, which may include information of multiple image frames.

With reference to FIG. 1 and FIG. 2, the second electronic device 120 may receive the bitstream from an encoder, such as the first electronic device 110, or from other video providers, via the second interface 126. The second interface 126 may provide the bitstream to the decoder module 124.

The entropy decoding unit 2241 may decode the bitstream to determine multiple prediction indications and multiple partitioning indications for multiple video images. The decoder module 124 may then reconstruct the video images based on the prediction indications and the partitioning indications. The prediction indications and the partitioning indications may include multiple flags and multiple indices.

At block 320, the method/process 300 may determine (e.g., by the decoder module 124), a block unit from an image frame retrieved from the video data. Specifically, the video data may include the bitstream received from the encoder, and a block unit may be determined from an image frame of the bitstream.

With reference to FIG. 1 and FIG. 2, the decoder module 124 may determine or retrieve the image frames from the bitstream and may divide each image frame to determine the block units, according to the partition indications in the bitstream. For example, the decoder module 124 may divide the image frames to generate multiple CTUs, and further divide one of the CTUs to determine the block units, according to the partition indications, using any video coding standard.

In some implementations, the block unit may be a current block. For example, the current block may include at least one of a coding unit, a prediction unit, a macroblock, a luma block, and a chroma block.

At block 330, the method/process 300 may determine block vector(s) from neighboring block(s) of the block unit. Each block vector may indicate a reference block associated with the block unit. In some implementations, the reference block, as described herein, may locate in the same image frame, as the block unit.

In some implementations, the decoder module 124 may determine a first block vector from a first neighboring block of the block unit, and the first block vector may indicate a first reference block associated with the block unit. In some implementations, the decoder module 124 may determine a second block vector from a second neighboring block of the block unit, and the second block vector may indicate a second reference block associated with the block unit.

For example, the neighboring block(s) may include one or more of the adjacent blocks. As another example, the neighboring block(s) may include one or more of the adjacent blocks and the non-adjacent blocks.

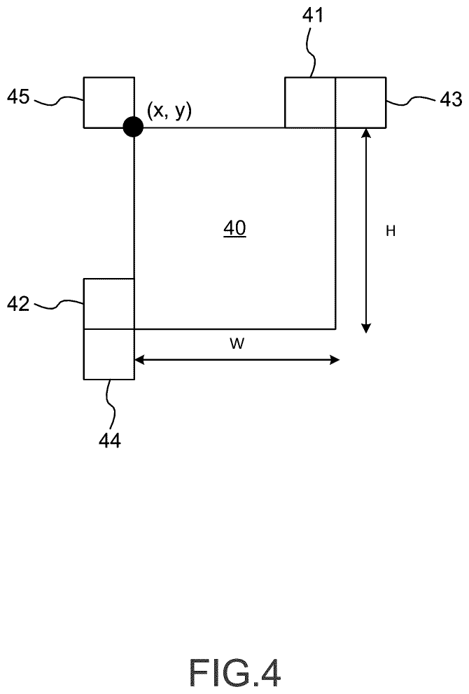

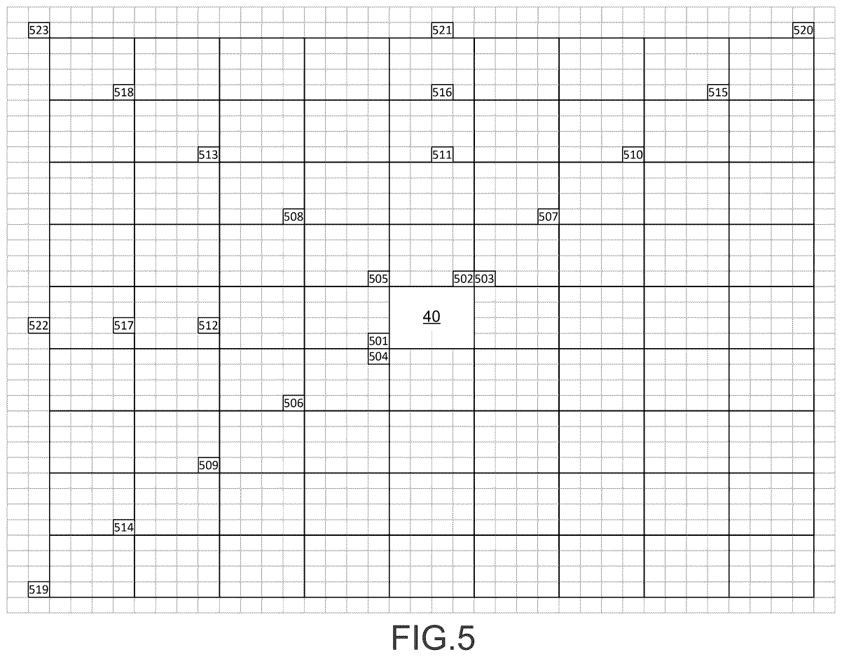

FIG. 4 is a diagram illustrating adjacent blocks of a block unit, in accordance with one or more example implementations of this disclosure. FIG. 5 is a diagram illustrating adjacent and non-adjacent blocks of the block unit, in accordance with one or more example implementations of this disclosure.

Referring to FIG. 4, adjacent blocks of the block unit 40 may include a top block 41, a left block 42, a top-right block 43, a bottom-left block 44, and a top-left block 45. The position of the top-left corner of the block unit 40 may be (x, y), the width of the block unit 40 may be W, and the height of the block unit 40 may be H, where W and H are positive integers. The top block 41 may be a block including a sample located at (x+W−1, y−1), the left block 42 may be a block including a sample located at (x−1, y+H−1), the top-right block 43 may be a block including a sample located at (x+W, y−1), the bottom-left block 44 may be a block including a sample located at (x−1, y+H), and the top-left block 45 may be a block including a sample located at (x−1, y−1).

Referring to FIG. 5, blocks 501 to 505 may be the adjacent blocks of the block unit 40, as described in FIG. 4. Blocks 506 to 523 may be the non-adjacent blocks of the block unit 40 (e.g., which may be the same as those defined for the inter merge mode). The distances between the non-adjacent (coded) blocks 506 to 523 and the block unit 40 may be determined based on the width and height of the block unit 40.

However, the definition of neighboring blocks (e.g., including adjacent blocks and/or non-adjacent blocks) of a block unit is not limited to what is described with reference to FIGS. 4 and 5. A person of ordinary skill in the art may adopt different definitions as needed, e.g., depending on the coding standard or implementation.

In some implementations, one or more neighboring blocks (e.g., the first neighboring block and the second neighboring block) of the block unit may be coded using an inter block copy (IBC) mechanism or an intra template matching prediction (IntraTMP) method, and one or more block vectors (e.g., the first block vector and the second block vector) may be determined from the one or more neighboring blocks.

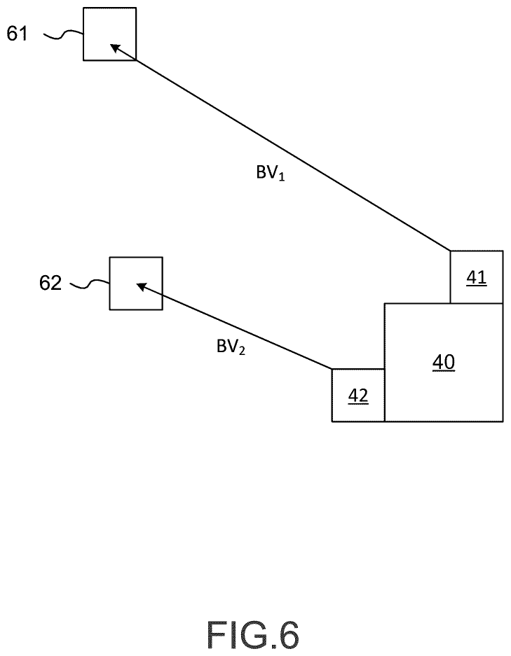

FIG. 6 is a diagram illustrating a block vector indicating a reference block, in accordance with one or more example implementations of this disclosure.

In FIG. 6, the block unit 40 may have a first neighboring block 41, which may be coded, for example, using either one of the IBC or IntraTMP. The first neighboring block 41 may be associated with (e.g., predicted based on) a first block vector BV₁. In other words, the first block vector BV₁ may be determined from the first neighboring block 41 of the block unit 40. The first block vector BV₁ may indicate a first reference block 61, which is located within the same image frame as the block unit 40.

In some implementations, the block unit 40 may have a second neighboring block 42, which may be coded by the IBC or IntraTMP. The second neighboring block 42 may be associated with (e.g., predicted based on) a second block vector BV₂. In other words, the second block vector BV₂ may be determined from the second neighboring block 42 of the block unit 40. The second block vector BV₂ may indicate a second reference block 62, which is located within the same image frame as the block unit 40.

Referring back to FIG. 3, at block 340, the method/process 300 may determine, based on the reference block(s), and using a matrix-based intra prediction mode, block prediction(s) for the block unit, when the reference block(s) satisfies a condition associated with a block size and a mode type of the reference block(s).

In some implementations, when the first reference block 61 satisfies the condition, the decoder module 124 may determine a first block prediction for the block unit 40 using the matrix-based intra prediction mode. For example, the decoder module 124 may determine multiple first prediction samples of the block unit 40 using the matrix-based intra prediction mode. In some implementations, when the second reference block 62 satisfies the condition, the decoder module 124 may determine a second block prediction for the block unit for the block unit 40 using the matrix-based intra prediction mode. For example, the decoder module 124 may determine multiple second prediction samples of the block unit 40 using the matrix-based intra prediction mode.

In some implementations, the condition may include a mode condition and a size condition, and the condition may be determined to be satisfied for a reference block when both the mode condition and the size condition are satisfied.

In some implementations, a specific matrix-based intra prediction mode may be associated with a corresponding intra prediction mode. For example, a first matrix-based intra prediction mode corresponding to at least one first matrix may be associated with a Planar mode, a second matrix-based intra prediction mode corresponding to at least one second matrix may be associated with a Direct Current (DC) mode, and a third matrix-based intra prediction mode corresponding to at least one third matrix may be associated with a specific angular mode. In other words, one or more conventional intra prediction modes may each be associated with a corresponding matrix-based intra prediction mode, and each matrix-based intra prediction mode may correspond to a different matrix.

In some implementations, the one or more conventional intra prediction modes associated with the matrix-based intra prediction may include the Planar mode, DC mode, and angular mode(s) with a mode index defined by a function of k (e.g., k is a positive constant), such as (2+2*k) or (2+4*k), etc. The mode condition may be determined to be satisfied when the reference block is coded using one of the one or more conventional intra prediction modes associated with the matrix-based intra prediction mode. In some implementations, the mode condition may be determined to be satisfied when the reference block is coded using one of the Planar mode, the DC mode, or the angular mode(s) with the mode index defined by a function of k, or a matrix-based intra prediction mode.

In some implementations, the size condition may be determined to be satisfied when each of a block width of the reference block and a block height of the reference block is smaller than, or equal to, 16 pixels. For example, the size condition of the reference block may be determined to be satisfied when the block size of the reference block is 16*16, 16*8, 16*4, 8*16, 8*8, 8*4, 4*16, 4*8, or 4*4.

In some implementations, the size condition may be determined to be satisfied when at least one of a block width of the reference block and a block height of the reference block is greater than, or equal to, 32 pixels. For example, the size condition of the reference block may be determined to be satisfied when the block size of the reference block is 16*32, 32*16, or 32*32.

In some implementations, the matrix-based intra prediction mode may be position-dependent. Specifically, one matrix-based intra prediction mode (e.g., a first matrix-based intra prediction mode) may be used to predict a target block unit (e.g., to generate predicted samples of the block unit 40, the first reference block 61, the second reference block 62, etc.) based on a weight matrix and a reference region of the target block unit, as expressed by the following equation:

$$P ( x , y ) = {\sum }_{n} F ( x , y , n ) * r ( n )$$

In the above equation, P(x, y) may indicate the predicted sample at the position (x, y) of the target block unit; r(n) may indicate the n-th reconstructed sample in the reference region; F(x, y, n) may indicate the weight of the n-th reconstructed sample in the reference region and located at the position (x, y) in the weight matrix; and n may be an index to indicate the sample in the reference region.

In some implementations, the weight matrix may be pre-defined. Each of the conventional intra modes with each block size, as described above, may correspond to a weight matrix, and each weight matrix may be different from the other ones. Each weight matrix may be used at both decoder side (for decoding) and encoder side (for encoding). In some implementations, the weight matrix may be pre-trained, for example, by a neural-network (NN) and may be pre-defined in both encoder and decoder sides.

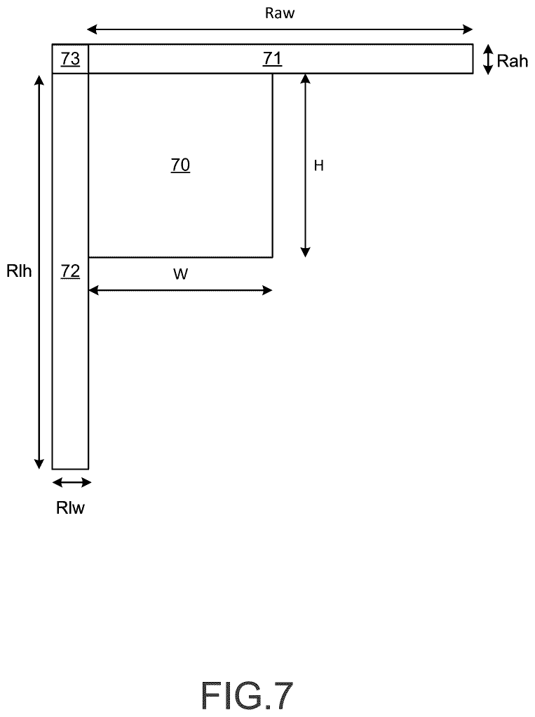

FIG. 7 is a diagram illustrating a reference region of a target block unit, in accordance with one or more example implementations of this disclosure.

Referring to FIG. 7, the reference region of a target block unit 70 may be located within a reconstructed region. In other words, the reference region may have been reconstructed before entering block 340 (as shown in FIG. 3). In some implementations, the reference region may include an above reference region 71, a left reference region 72 and/or an above-left reference region 73. The size of the reference region may be determined based on the block size of the target block unit 70 and the associated mode type (e.g., the mode index of the associated conventional intra prediction mode).

In some implementations, the height ‘Rah’ of the above reference region 71 and the width ‘Rlw’ of the left reference region 72 may be determined based on the block size of the target block unit 70. For example, the height ‘Rah’ of the above reference region 71 and the width ‘Rlw’ of the left reference region 72 may be equal to 2, if both of the width W and the height H of the target block unit 70 are smaller than, or equal to, 16. As another example, the height ‘Rah’ of the above reference region 71 and the width ‘Rlw’ of the left reference region 72 may be equal to 1, if one of the width W or height H of the target block unit 70 is greater than, or equal to, 32. For example, the height ‘Rah’ of the above reference region 71 and the width ‘Rlw’ of the left reference region 72 may be equal to 2 when the block size of the target block unit 70 is 16*16, 16*8, 16*4, 8*16, 8*8, 8*4, 4*16, 4*8, or 4*4. As another example, the height Rah of the above reference region 71 and the width Rlw of the left reference region 72 may be equal to 1 when the block size of the target block unit 70 is 16*32, 32*16 or 32*32.

In some implementations, the above reference region 71, the left reference region 72, and/or the above-left reference region 73 may be adjacent to the target block unit 70, as shown in FIG. 7. For example, the above reference region 71 and/or the left reference region 72 may include a reference line adjacent to the target block unit 70.

In some implementations, the above reference region 71, the left reference region 72, and/or above-left reference region 73 may not be adjacent to the target block unit 70. For example, the above reference region 71 and/or the left reference region 72 may include one or more reference lines that are separated from a boundary of the target block unit 70, for example, by one or more pixels in width. In some implementations, the one or more non-adjacent reference lines may be predefined. In some implementations, the one or more non-adjacent reference lines may be determined from a non-adjacent reference line list, such as {1, 2, 3, 5, 13}, which may represent five non-adjacent reference lines separated from the boundary of the target block unit 70 by 1, 2, 3, 5, and 13 pixels, respectively.

In some implementations, when the decoder module 124 determines, based on a reference block and using a matrix-based intra prediction mode, a block prediction for the block unit 40, the decoder module 124 may apply, on the reference block, the matrix-based intra prediction mode associated with the intra prediction mode, by which the reference block is coded, to generate a reference prediction of the reference block. For example, when the first reference block 61 satisfies the condition and is coded using a first intra prediction mode (e.g., a Planar mode, a DC mode, an angular mode with a mode index defined by a function of k, or a matrix-based intra prediction mode), the decoder module 124 may apply a first matrix-based intra prediction mode on the first reference block 61 to generate a first reference prediction of the first reference block 61. The first matrix-based intra prediction mode may be associated with the first intra prediction mode and the first reference prediction generated may be served as a first block prediction for the block unit 40. As another example, when the second reference block 62 satisfies the condition and is coded using a second intra prediction mode (e.g., a Planar mode, a DC mode, an angular mode with a mode index defined by a function of k, or a matrix-based intra prediction mode), the decoder module 124 may apply a second matrix-based intra prediction mode associated with the second intra prediction mode on the second reference block 62 to generate a second reference prediction of the second reference block 62, to serve as a second block prediction for the block unit 40.

In some implementations, when the decoder module 124 determines, based on a reference block and using a matrix-based intra prediction mode, a block prediction for the block unit 40, the decoder module 124 may apply, on the block unit 40, the matrix-based intra prediction mode associated with the intra prediction mode by which the reference block is coded, to generate a block prediction for the block unit 40. For example, when the first reference block 61 satisfies the condition and is coded using a first intra prediction mode (e.g., a Planar mode, a DC mode, an angular mode with a mode index defined by a function of k, or a matrix-based intra prediction mode), the decoder module 124 may apply a first matrix-based intra prediction mode associated with the first intra prediction mode on the block unit 40 to generate a first block prediction for the block unit 40. As another example, when the second reference block 62 satisfies the condition and is coded by a second intra prediction mode (e.g., a Planar mode, a DC mode, an angular mode with a mode index defined by a function of k, or a matrix-based intra prediction mode), the decoder module 124 may apply a second matrix-based intra prediction mode associated with the second intra prediction mode on the block unit 40 to generate a second block prediction for the block unit 40.

In some implementations, a block prediction, determined based on a reference block and using a matrix-based intra prediction mode, may be included in (or added to) a set of prediction candidates, as a new prediction candidate. The prediction candidates (e.g., in the set of prediction candidates) for the block unit 40 may be used for subsequent reconstruction of the block unit. For example, each of the first block prediction, determined based on the first reference block 61 and using the first matrix-based intra prediction mode, and the second block prediction, determined based on the second reference block 62 and using the second matrix-based intra prediction mode, may be included, or added, to the set, as one of multiple prediction candidates.

In some implementations, a reference prediction of a reference block may be one of multiple prediction candidates, and a block prediction, determined based on the reference block and using a matrix-based intra prediction mode, may replace the reference prediction, among the multiple prediction candidates. In some implementations, whether the block prediction, determined based on the reference block and using the matrix-based intra prediction mode, replaces the reference prediction, among the multiple prediction candidates, may depend on the template cost. For example, the decoder module 124 may calculate the template cost for both the reference prediction and the block prediction, and determine to replace the reference prediction with the block prediction when the block prediction has a smaller template cost. It should be noted that, the template cost may be determined by calculating a difference between a template prediction and a template reconstruction using a specific metric, such as the Sum of Absolute Differences (SAD), the Sum of Absolute Transformed Differences (SATD), the Mean Removal Sum of Absolute Difference (MRSAD), or the Mean Square Error (MSE).

Referring back to FIG. 3, at block 350, the method/process 300 may reconstruct the block unit based on the block prediction(s).

In some implementations, the decoder module 124 may determine the predicted samples of the block unit, then reconstruct the block unit based on the predicted samples. In some implementations, the decoder module 124 may add multiple residual components to the predicted samples of the block unit to reconstruct the block unit. The residual components may be determined from the bitstream. Once the block unit is reconstructed, the method/process 300 may then end. By repeating the method/process 300, multiple block units may be reconstructed and, as a result, the image frames included in the video data may be reconstructed accordingly.

In some implementations, the decoder module 124 may determine the predicted samples based on the block prediction(s), determined at block 340. For example, the decoder module 124 may determine the predicted samples of the block unit 40 based on the first block prediction, determined from the first reference block 61, and/or the second block prediction, determined from the second reference block 62.

In some implementations, the decoder module 124 may determine the predicted samples based on the multiple prediction candidates, determined before entering the block 350.

For example, each of the multiple prediction candidates may be generated for the block unit 40 using one of several prediction modes, including a planar mode, a DC mode, an angular mode, a Template-based Intra Mode Derivation (TIMD), a Decoder-Side Intra Mode Derivation (DIMD), a matrix-based intra prediction mode, an Offset-based Intra Block Copy (OBIC), or a Spatial Geometric Partitioning Mode (SGPM). As an example, the multiple prediction candidates may include a first block prediction generated based on the first reference block 61 using the first matrix-based intra prediction mode, and a second block prediction generated based on the second reference block 62 using the second matrix-based intra prediction mode.

The decoder module 124 may select one of the multiple prediction candidates to determine the predicted samples. For example, the decoder module 124 may select at least two of the multiple prediction candidates and weighted blend the selected at least two prediction candidates to determine the predicted samples of the block unit. It should be noted that the weights for blending the selected prediction candidates may be determined based on the template cost.

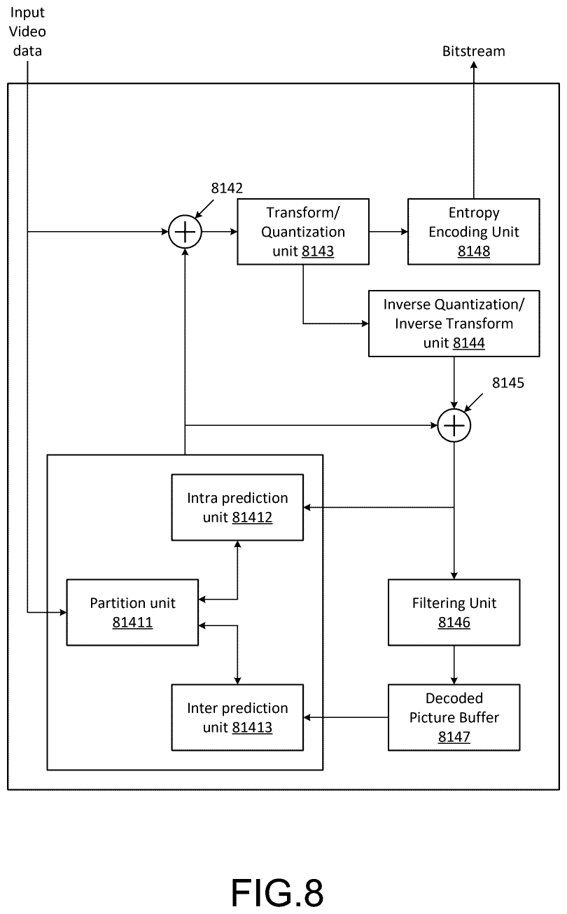

FIG. 8 is a block diagram illustrating an encoder module 114 of the first electronic device 110 illustrated in FIG. 1, in accordance with one or more example implementations of this disclosure. The encoder module 114 may include a prediction processor (e.g., a prediction processing unit 8141), at least a first summer (e.g., a first summer 8142) and a second summer (e.g., a second summer 8145), a transform/quantization processor (e.g., a transform/quantization unit 8143), an inverse quantization/inverse transform processor (e.g., an inverse quantization/inverse transform unit 8144), a filter (e.g., a filtering unit 8146), a decoded picture buffer (e.g., a decoded picture buffer 8147), and an entropy encoder (e.g., an entropy encoding unit 8148). The prediction processing unit 8141 of the encoder module 114 may further include a partition processor (e.g., a partition unit 81411), an intra prediction processor (e.g., an intra prediction unit 81412), and an inter prediction processor (e.g., an inter prediction unit 81413).

The encoder module 114 may receive the source video and encode the source video to output a bitstream. The encoder module 114 may receive source video including multiple image frames and then divide the image frames according to a coding structure. Each of the image frames may be divided into at least one image block.

The at least one image block may include a luminance block having multiple luminance samples and at least one chrominance block having multiple chrominance samples. The luminance block and the at least one chrominance block may be further divided to generate macroblocks, CTUs, CBs, sub-divisions thereof, and/or other equivalent coding units.

The encoder module 114 may perform additional sub-divisions of the source video. It should be noted that the disclosed implementations are generally applicable to video coding regardless of how the source video is partitioned prior to and/or during the encoding.

During the encoding process, the prediction processing unit 8141 may receive a current image block of a specific one of the image frames. The current image block may be the luminance block or one of the chrominance blocks in the specific image frame.

The partition unit 81411 may divide the current image block into multiple block units. The intra prediction unit 81412 may perform intra-predictive coding of a current block unit relative to one or more neighboring blocks in the same frame as the current block unit in order to provide spatial prediction. The inter prediction unit 81413 may perform inter-predictive coding of the current block unit relative to one or more blocks in one or more reference image blocks to provide temporal prediction.

The prediction processing unit 8141 may select one of the coding results generated by the intra prediction unit 81412 and the inter prediction unit 81413 based on a mode selection method, such as a cost function. The mode selection method may be a rate-distortion optimization (RDO) process.

The prediction processing unit 8141 may determine the selected coding result and provide a predicted block corresponding to the selected coding result to the first summer 8142 for generating a residual block and to the second summer 8145 for reconstructing the encoded block unit. The prediction processing unit 8141 may further provide syntax elements, such as motion vectors, intra-mode indicators, partition information, and/or other syntax information, to the entropy encoding unit 8148.

The intra prediction unit 81412 may intra-predict the current block unit. The intra prediction unit 81412 may determine an intra prediction mode directed toward a reconstructed sample neighboring the current block unit in order to encode the current block unit.

The intra prediction unit 81412 may encode the current block unit using various intra prediction modes. The intra prediction unit 81412 of the prediction processing unit 8141 may select an appropriate intra prediction mode from the selected modes. The intra prediction unit 81412 may encode the current block unit using a cross-component prediction mode to predict one of the two chroma components of the current block unit based on the luma components of the current block unit. The intra prediction unit 81412 may predict a first one of the two chroma components of the current block unit based on the second of the two chroma components of the current block unit.

The inter prediction unit 81413 may inter-predict the current block unit as an alternative to the intra prediction performed by the intra prediction unit 81412. The inter prediction unit 81413 may perform motion estimation to estimate motion of the current block unit for generating a motion vector.

The motion vector may indicate a displacement of the current block unit within the current image block relative to a reference block unit within a reference image block. The inter prediction unit 81413 may receive at least one reference image block stored in the decoded picture buffer 8147 and estimate the motion based on the received reference image blocks to generate the motion vector.

The first summer 8142 may generate the residual block by subtracting the prediction block determined by the prediction processing unit 8141 from the original current block unit. The first summer 8142 may represent the component or components that perform this subtraction.

The transform/quantization unit (143 may apply a transform to the residual block in order to generate a residual transform coefficient and then quantize the residual transform coefficients to further reduce the bit rate. The transform may be one of a DCT, DST, AMT, MDNSST, HyGT, signal-dependent transform, KLT, wavelet transform, integer transform, sub-band transform, and a conceptually similar transform.

The transform may convert the residual information from a pixel value domain to a transform domain, such as a frequency domain. The degree of quantization may be modified by adjusting a quantization parameter.

The transform/quantization unit 8143 may perform a scan of the matrix including the quantized transform coefficients. Alternatively, the entropy encoding unit 8148 may perform the scan.

The entropy encoding unit 8148 may receive multiple syntax elements from the prediction processing unit 8141 and the transform/quantization unit (143, including a quantization parameter, transform data, motion vectors, intra modes, partition information, and/or other syntax information. The entropy encoding unit 8148 may encode the syntax elements into the bitstream.

The entropy encoding unit 8148 may entropy encode the quantized transform coefficients by performing CAVLC, CABAC, SBAC, PIPE coding, or another entropy coding technique to generate an encoded bitstream. The encoded bitstream may be transmitted to another device (e.g., the second electronic device 120, as shown in FIG. 1) or archived for later transmission or retrieval.

The inverse quantization/inverse transform unit 8144 may apply inverse quantization and inverse transformation to reconstruct the residual block in the pixel domain for later use as a reference block. The second summer 8145 may add the reconstructed residual block to the prediction block provided by the prediction processing unit 8141 in order to produce a reconstructed block for storage in the decoded picture buffer 8147.

The filtering unit 8146 may include a deblocking filter, an SAO filter, a bilateral filter, and/or an ALF to remove blocking artifacts from the reconstructed block. Other filters (in loop or post loop) may be used in addition to the deblocking filter, the SAO filter, the bilateral filter, and the ALF. Such filters are not illustrated for brevity and may filter the output of the second summer 8145.

The decoded picture buffer 8147 may be a reference picture memory that stores the reference block to be used by the encoder module 114 to encode video, such as in intra-coding or inter-coding modes. The decoded picture buffer 8147 may include a variety of memory devices, such as DRAM (e.g., including SDRAM), MRAM, RRAM, or other types of memory devices. The decoded picture buffer 8147 may be on-chip with other components of the encoder module 114 or off-chip relative to those components.

The method/process 300 for decoding/encoding video data may be performed by the first electronic device 110. The encoder module 114 may receive the video data. The video data received by the encoder module 114 may be a video. The encoder module 114 may determine a block unit from an image frame retrieved from the video data. The encoder module 114 may divide the image frame to generate multiple CTUs, and further divide one of the CTUs to determine the block unit, according to one of multiple partition schemes, based on any video coding standard.

With respect to the block unit, the encoder module 114 may determine block vector(s) from neighboring block(s) of the block unit, each block vector may indicate a reference block associated with the block unit. Details for the neighboring block(s) of the block unit, the block vector(s), and the reference block(s) are described above (e.g., as illustrated in block 330 of FIG. 3) and therefore are not repeated herein.

The encoder module 114 may use the method/process 300 to determine, based on the reference block(s) and using a matrix-based intra prediction mode, block prediction(s) for the block unit when the reference block(s) satisfies a condition associated with a block size and a mode type of the reference block. Details for the determination of the block prediction(s), based on the reference block(s) and using the matrix-based intra prediction mode, are described above (e.g., as shown in block 340 of FIG. 3) and therefore are not repeated herein.

The encoder module 114 may use the method/process 300 to reconstruct the block unit based on the block prediction(s) of the block unit. Details for the reconstruction for the block unit are described above (e.g., as shown in blocks 350 FIG. 3) and therefore are not repeated herein. The reconstructed block unit may include multiple reconstructed samples, which may be used as references for predicting subsequent blocks in the video data.

The disclosed implementations are to be considered in all respects as illustrative and not restrictive. It should also be understood that the present disclosure is not limited to the specific disclosed implementations, but that many rearrangements, modifications, and substitutions are possible without departing from the scope of the present disclosure.

What is claimed is:

1. An electronic device for decoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit from an image frame retrieved from the video data;
determine a first block vector from a neighboring block of the block unit, the first block vector indicating a first reference block;
determine, based on the first reference block and using a matrix-based intra prediction mode, a first block prediction for the block unit when the first reference block satisfies a condition associated with a block size and a mode type of the first reference block; and
reconstruct the block unit based on the first block prediction.

2. The electronic device of claim 1, wherein determining the first block prediction for the block unit comprises:
determining, based on a reference region of the first reference block and using the matrix-based intra prediction mode, a reference prediction for the first reference block.

3. The electronic device of claim 2, wherein the reference region comprises a reference line adjacent to the first reference block.

4. The electronic device of claim 2, wherein the reference region comprises a reference line separated from a boundary of the first reference block.

5. The electronic device of claim 4, wherein the reference line is separated from the boundary of the first reference block by one or more pixels in width, and the reference line is located within a reconstructed region.

6. The electronic device of claim 1, wherein the one or more computer-executable instructions, when executed by the at least one processor, further cause the electronic device to:
add the first block prediction as a prediction candidate to a plurality of prediction candidates for the block unit,
wherein reconstructing the block unit based on the first block prediction comprises reconstructing the block unit based on the plurality of prediction candidates.

7. The electronic device of claim 6, wherein the one or more computer-executable instructions, when executed by the at least one processor, further cause the electronic device to:
determine a second block vector from another neighboring block of the block unit, the second block vector indicating a second reference block;
determine, based on the second reference block and using the matrix-based intra prediction mode, a second block prediction for the block unit when the second reference block satisfies the condition; and
add the second block prediction as another prediction candidate to the plurality of prediction candidates for the block unit.

8. The electronic device of claim 1, wherein the first reference block satisfies the condition when:
each of a block width of the first reference block and a block height of the first reference block is smaller than or equal to 16 pixels, and
the mode type of the first reference block is one of a planar mode, a direct current (DC) mode, and an angular mode having a mode index defined by a function of k, wherein k is a positive constant.

9. The electronic device of claim 1, wherein the first reference block satisfies the condition when:
at least one of a block width of the first reference block and a block height of the first reference block is greater than, or equal to, 32 pixels, and
the mode type of the first reference block is one of a planar mode, a direct current (DC) mode, and an angular mode having a mode index defined by a function of k, wherein k is a positive constant.

10. An electronic device for encoding video data, the electronic device comprising:
at least one processor; and
at least one non-transitory computer-readable medium coupled to the at least one processor and storing one or more computer-executable instructions that, when executed by the at least one processor, cause the electronic device to:
receive the video data;
determine a block unit from an image frame retrieved from the video data;
determine a first block vector from a neighboring block of the block unit, the first block vector indicating a first reference block;
determine, based on the first reference block and using a matrix-based intra prediction mode, a first block prediction for the block unit when the first reference block satisfies a condition associated with a block size and a mode type of the reference block; and
reconstruct the block unit based on the first block prediction.

11. The electronic device of claim 10, wherein determining the first block prediction for the block unit comprises:
determining, based on a reference region of the first reference block and using the matrix-based intra prediction mode, a reference prediction for the first reference block.

12. The electronic device of claim 11, wherein the reference region comprises a reference line adjacent to the first reference block.

13. The electronic device of claim 11, wherein the reference region comprises a reference line separated from a boundary of the first reference block.

14. The electronic device of claim 13, wherein the reference line is separated from the boundary of the first reference block by one or more pixels in width, and the reference line is located within a reconstructed region.

15. The electronic device of claim 10, wherein the one or more computer-executable instructions, when executed by the at least one processor, further cause the electronic device to:
add the first block prediction as a prediction candidate to a plurality of prediction candidates for the block unit,
wherein reconstructing the block unit based on the first block prediction comprises reconstructing the block unit based on the plurality of prediction candidates.

16. The electronic device of claim 15, wherein the one or more computer-executable instructions, when executed by the at least one processor, further cause the electronic device to:
determine a second block vector from another neighboring block of the block unit, the second block vector indicating a second reference block;
determine, based on the second reference block and using the matrix-based intra prediction mode, a second block prediction for the block unit when the second reference block satisfies the condition; and
add the second block prediction as another prediction candidate to the plurality of prediction candidates for the block unit.

17. The electronic device of claim 10, wherein the first reference block satisfies the condition when:
each of a block width of the first reference block and a block height of the first reference block is smaller than or equal to 16 pixels, and
the mode type of the first reference block is one of a planar mode, a direct current (DC) mode, and an angular mode having a mode index defined by a function of k, wherein k is a positive constant.

18. The electronic device of claim 10, wherein the first reference block satisfies the condition when:
at least one of a block width of the first reference block and a block height of the first reference block is greater than or equal to 32 pixels, and
the mode type of the first reference block is one of a planar mode, a direct current (DC) mode, and an angular mode having a mode index defined by a function of k, wherein k is a positive constant.

19. A non-transitory machine-readable medium of an electronic device storing one or more computer-executable instructions for decoding video data, the one or more computer-executable instructions, when executed by at least one processor of the electronic device, causing the electronic device to:
receive the video data;
determine a block unit from an image frame retrieved from the video data;
determine a first block vector from a neighboring block of the block unit, the first block vector indicating a first reference block;
determine, based on the first reference block and using a matrix-based intra prediction mode, a first block prediction for the block unit when the first reference block satisfies a condition associated with a block size and a mode type of the first reference block; and
reconstruct the block unit based on the first block prediction.
